(19) United States
(12) Patent Application Publication
(10) Pub. No.: US 2008/0158601 A1
(43) Pub. Date: Jul. 3, 2008

(54) Image memory tiling

(76) Inventors: Steven Tu, Phoenix, AZ (US); Dmitrii Loukianov, Chandler, AZ (US)

Correspondence Address: BUCKLEY, MASCHOFF & TALWALKAR LLC, 50 LOCUST AVENUE, NEW CANAAN, CT, 06840, US

(21) Appl. No.: 11/648,117

(22) Filed: Dec. 29, 2006

(51) Int. Cl. G06K 15/00

(52) U.S. Cl. 358/1.16

(57) ABSTRACT

According to some embodiments, image information, including rows of pixels, may be determined. The image information may be associated with a plurality of image blocks, each image block including a subset of pixels from multiple rows. Moreover, a single row of pixels of the image information may span multiple image blocks. A first subset of pixels (from a first row of a first image block) may be stored into a memory unit. A second subset of pixels (from a second row of the first image block) may then be stored into the memory unit such that a first pixel of the second subset is stored proximate to a last pixel of the first subset.

### BACKGROUND

A media player may output moving images to a display device. For example, a media player might retrieve locally stored image information or receive a stream of image information from a media server (e.g., a content provider might transmit a stream that includes high-definition image frames to a television, a set-top box, or a digital video recorder through a cable or satellite network). In some cases, the image information is encoded to reduce the amount of data used to represent the image. For example, an image might be divided into smaller image portions, such as macroblocks, so that information encoded with respect to one image portion does not need to be repeated with respect to another image portion (e.g., because neighboring image portions may frequently have similar color and brightness characteristics). Moreover, image information may be stored into and accessed from memory when an image is decoded or otherwise processed. Thus, improving the efficiency of accessing image information in memory may improve the performance of a media device.

### BRIEF DESCRIPTION OF THE DRAWINGS

FIG. 1 is a block diagram of a media system.

FIG. 2 illustrates a display and an image block.

FIG. 3 illustrates a display and an image block according to some embodiments.

FIG. 4 is a flow diagram illustrating a method according to some embodiments.

FIG. 5 illustrates image blocks according to some embodiments.

FIG. 6 illustrates a display, an image block, and an image sub-block according to some embodiments.

FIG. 7 illustrates image sub-blocks according to some embodiments.

FIG. 8 is a block diagram of an apparatus according to some embodiments.

FIG. 9 illustrates a non-aligned macroblock according to some embodiments.

FIG. 10 is a block diagram of a system according to some embodiments.

### DETAILED DESCRIPTION

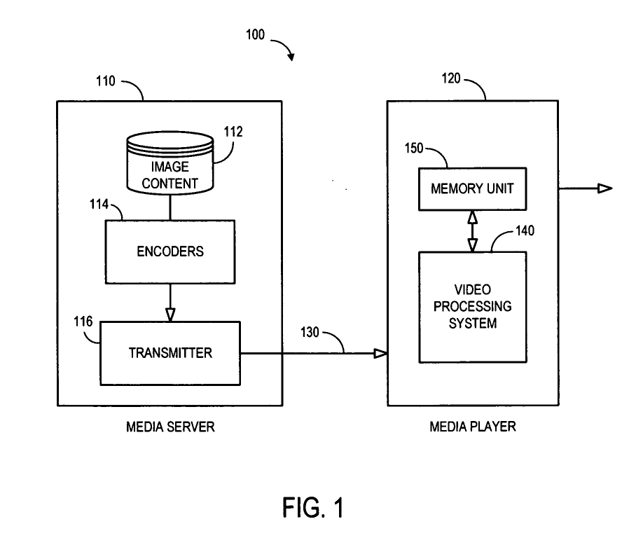

A media player may receive image information, decode the information, and output a signal to a display device. For example, a Digital Video Recorder (DVR) might retrieve locally stored image information, or a set-top box might receive a stream of image information from a remote device (e.g., a content provider might transmit a stream that includes high-definition image frames to the set-top box through a cable or satellite network). FIG. 1 is a block diagram of a media system 100 including a media server 110 that provides image information to a remote media player 120 through a communication network 130.

An encoder 114 may reduce the amount of data that is used to represent image content 112 before the data is transmitted by a transmitter 116 as a stream of image information. As used herein, information may be encoded and/or decoded in accordance with any of a number of different protocols. For example, image information may be processed in connection with International Telecommunication Union-Telecommunications Standardization Sector (ITU-T) recommendation H.264 entitled “Advanced Video Coding for Generic Audiovisual Services” (2004) or the International Organization for Standardization (ISO)/International Engineering Consortium (IEC) Motion Picture Experts Group (MPEG) standard entitled “Advanced Video Coding (Part 10)” (2004). As other examples, image information may be processed in accordance with ISO/IEC document number 14496 entitled “MPEG-4 Information Technology—Coding of Audio-Visual Objects” (2001) or the MPEG2 protocol as defined by ISO/IEC document number 13818-1 entitled “Information Technology—Generic Coding of Moving Pictures and Associated Audio Information” (2000).

An image may be divided into smaller image portions which can be decoded or otherwise processed by a video processing system 140 of the media player 120. Moreover, the media player 120 may store image information in a memory unit 150 located locally at, or external to, the video processing system 140.

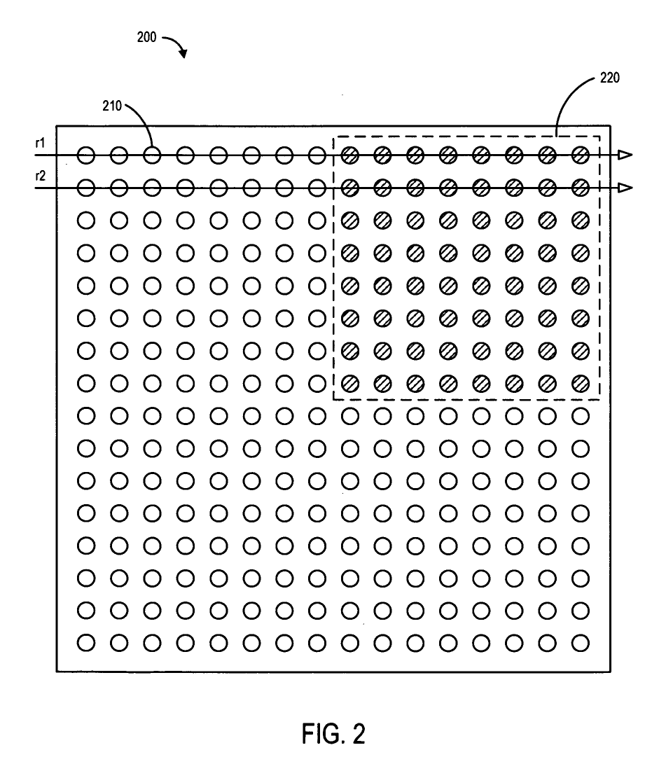

Consider, for example, MPEG or H.264 image information. As illustrated in FIG. 2, a display image 200 may comprise rows of pixels 210 (e.g., row r1 and row r2). Moreover, the set of pixels 210 may be divided into a number of image blocks 220 (e.g., macroblocks). Note that the video processing system 140 might store the pixels (e.g., data associated with each pixel) in the memory unit 150, from left to right, on a row-by-row basis. For example, the pixels of row r2 might be stored in a range of memory addresses immediately following those associated with the pixels of row r1.

Such an approach however, may limit the efficiency of the video processing system 140. Consider, for example, what might happen when the video processing system 140 needs to access all of the pixels associated with the image block 220 (illustrated with cross-hatched pixels in FIG. 2). In this case, the needed pixels would be stored in non-contiguous areas of the memory unit. As a result, the overhead associated with access the information may be substantial (e.g., memory pages may need to be opened and closed as the pixel data is accessed).

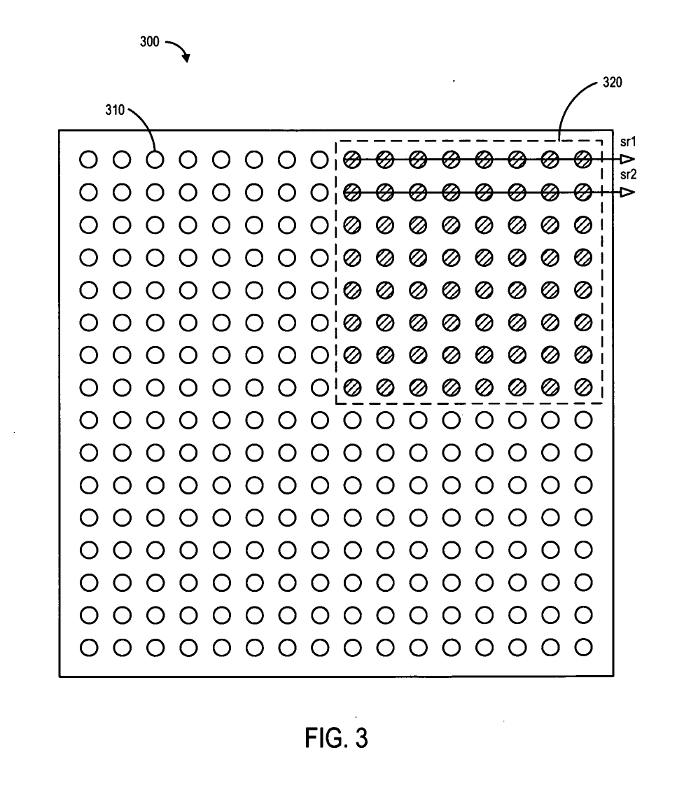

FIG. 3 illustrates a display 300 of pixels 310 and an image block 320 according to some embodiments. As before, each image block 320 will include a subset of the pixels that are in an image row (e.g., sub-row sr1 and sub-row sr2). According to this embodiment, these sub-rows are stored proximate to each other in the memory unit 150. For example, the pixels of sub-row r2 might be stored, from left to right, in a range of memory addresses immediately following those associated with the pixels of sub-row r2. That is, the pixels of image block 320 may be stored using a z-traverse memory tiling algorithm.

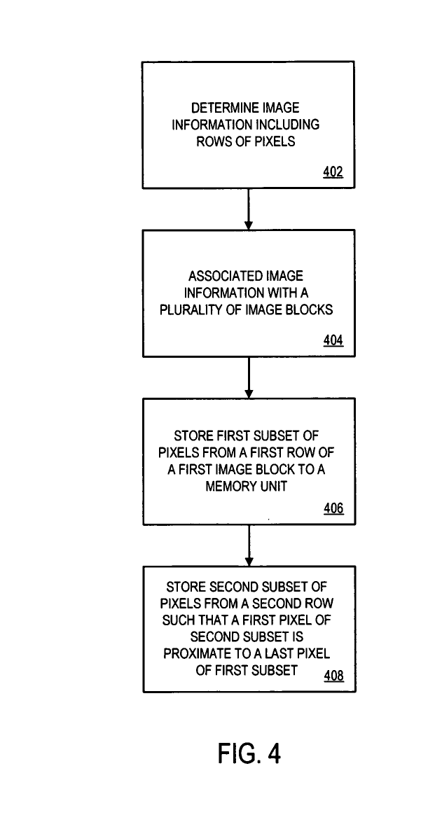

FIG. 4 is a flow diagram illustrating a method according to some embodiments. The method may be performed, for example, by the video processing system 140 of FIG. 1. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 402, image information is determined, the image information including rows of pixels. The image information may comprise, for example, MPEG image information. At 402, the image information is associated with a plurality of image blocks, each image block including a subset of pixels from multiple rows. Note that a single row of pixels of the image information may span multiple image blocks.

At 404, a first subset of pixels from a first row of a first image block are accessed (e.g., stored or retrieved) from a memory unit. In the example of FIG. 3, the pixels of sub-row sr1 might be stored, from left to right, in memory. At 406, a second subset of pixels from a second row of the first image block are accessed from the memory unit such that a first pixel of the second subset is stored proximate to a last pixel of the first subset. For example, the first pixel of sub-row sr2 might immediately follow the last pixel of sub-row sr1. As a result, the first pixel of the second subset might be stored in a same memory unit page as the last pixel of the first subset (improving the efficiency of memory accesses).

The storage and/or retrieval of pixels may be associated with a translation of a virtual image memory address into a tiled physical memory address. For example, a requested virtual image memory address might be translated into a requested tiled physical memory address. Pixel data may then be retrieved from the memory unit in accordance with the requested tiled physical memory address. Moreover, the retrieved pixel data can then be associated with the requested virtual image memory address.

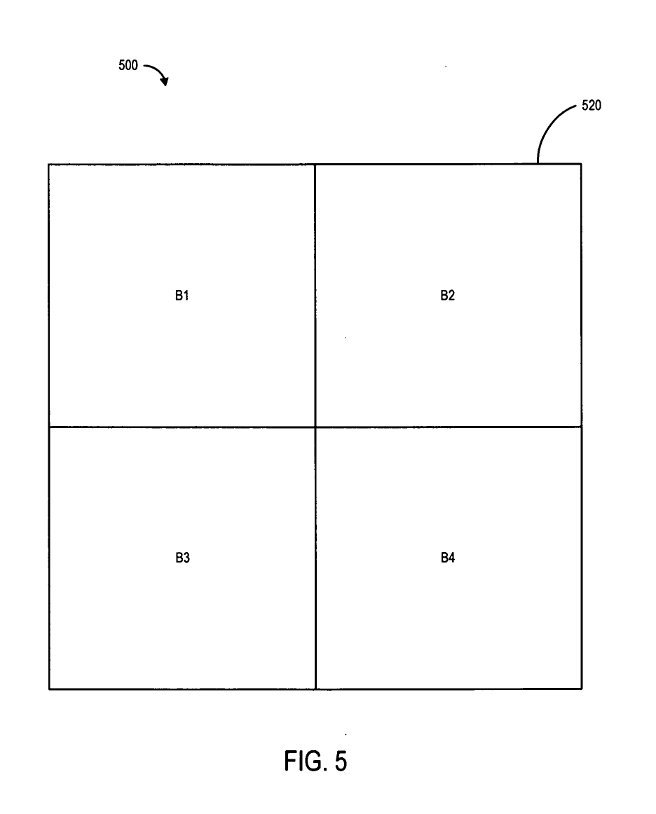

Note that a similar z-traverse memory tiling algorithm approach might be used on an image block-by-image block basis. For example, FIG. 5 illustrates a display 510 having four image blocks 520 (B1 through B4) according to some embodiments. According to this embodiment, pixels of the first image block Bland the second image block B2 may be stored such that the first pixel of the second image block B2 is stored proximate to a last pixel of the first image block B1. Similarly, the pixels of the second image block B2 may be followed by those of B3 (and then those of B4).

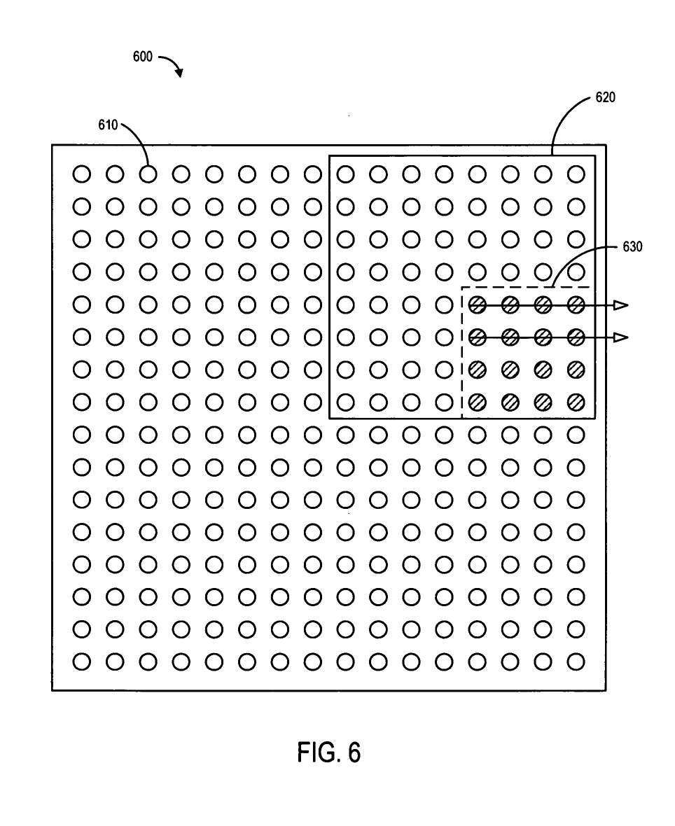

Also note that some image protocols further divide image blocks into image sub-blocks. For example, FIG. 6 illustrates a display 600, an image block 620, and an image sub-block 630 according to some embodiments. In this case, each image sub-block 630 may include a subset of pixels from multiple rows (and a single row of pixels of an image block 620 will span multiple image sub-blocks 630). According to this embodiment, a first subset of pixels from a first row of a first image sub-block 630 may be stored into a memory unit (e.g., from left to right). A second subset of pixels from a second row of the first image sub-block may then be stored (e.g., from left to right) into the memory unit such that a first pixel of the second subset is stored proximate to a last pixel of the first subset.

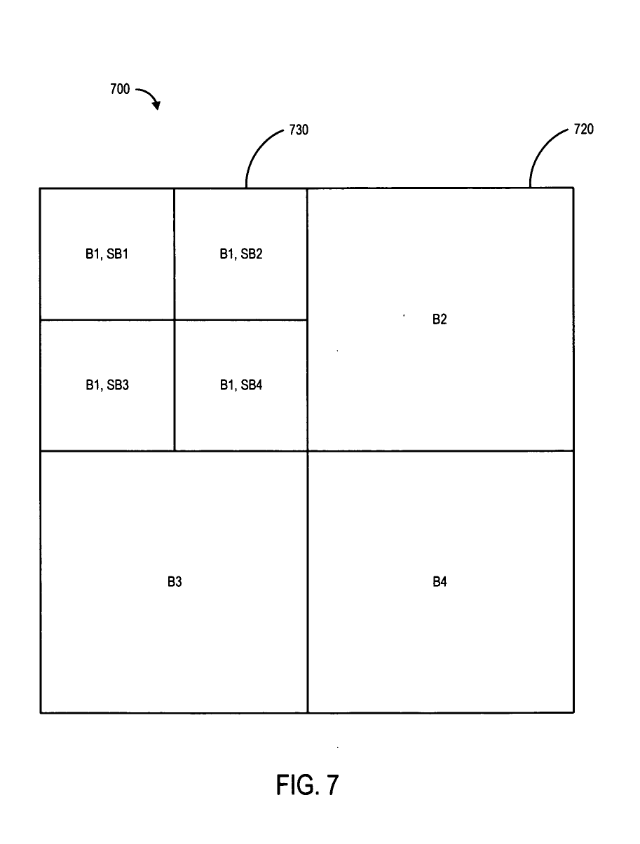

Moreover, a similar z-traverse memory tiling algorithm approach might be used on an image sub-block-by-image sub-block basis. For example, FIG. 7 illustrates a display 710 having four image blocks 720 (B1 through B4) according to some embodiments. Each image block is divided into image sub-blocks (e.g., image block B1 is divided into B1, SB1 through B1, SB4). According to this embodiment, pixels of the first image sub-block B1, SB1 and the second image sub-block B1, SB2 may be stored such that the first pixel of the second image sub-block B1, SB2 is stored proximate to a last pixel of the first image sub-block B1,SB1. Similarly, the pixels of the second image sub-block B1, B2 may be followed by those of B1, SB3 (and then those of B1, SB4).

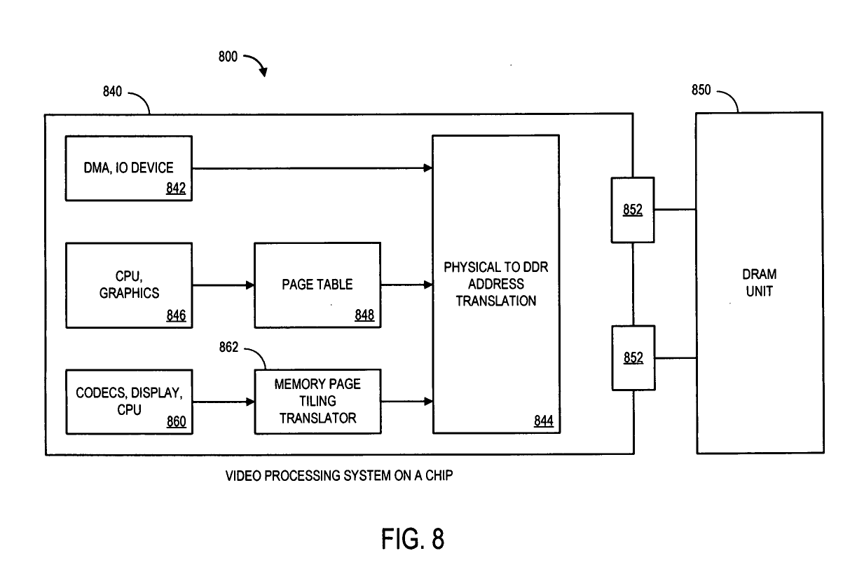

FIG. 8 is a block diagram of an apparatus 800 according to some embodiments. The apparatus 800 might include a video processing System On a Chip (SOC) 840 that exchanges information with a Dynamic Random Access Memory (DRAM) unit 850 via one or more Multi-port, Multi-channel Memory Controller (MMMC) ports 852. The DRAM unit 850 might comprise for, for example, a Double Data Rate (DDR) Synchronous DRAM (SDRAM) unit.

In some cases, a Direct Memory Access (DMA) or Input Output (IO) device 842 may need to access the DRAM unit 850. In this case, the DMA or IO device 842 might simply provide a linear/logical address (that is a linear physical address) to a physical-to-DDR address translation device 844 (e.g., associated with a MMMC 852), which can generate the DDR address for the DRAM unit (e.g., including a row and column). In other cases, a CPU or graphics device 844 may need to access the DRAM unit 850. In this case, the CPU or graphics device 84 may provide memory access request as a linear virtual address to a page table 848 which performs a virtual-to-physical address translation. The page table 848 may then provide the linear physical address to the physical-to-DDR address translation device 844 (e.g., associated with a MMMC 852), which can generate the DDR address (e.g., including a row and column).

According to some embodiments, a codec, display, or CPU device 860 may instead request to access the DRAM unit 850 using a tiled, two-dimensional, virtual address. The request may, for example, be provided to a memory page tiling translator 862 that translates the virtual tile and generates a tiled physical address for the physical-to-DDR address translation device 844 which can generate the DDR address.

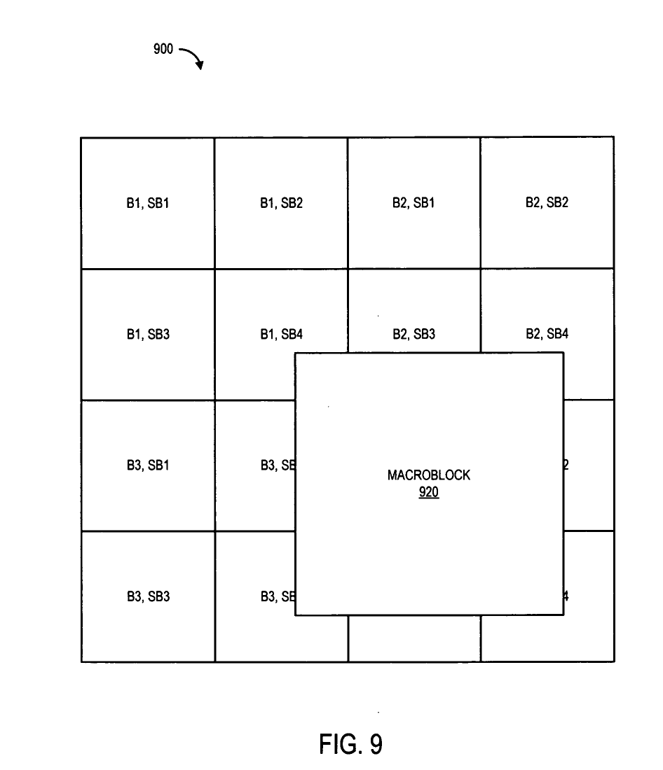

Note that the size of each image tile may determine an efficiency associated with memory accesses. Consider, for example, a 16×16 pixel display divided into 8×8 image blocks and 4×4 image sub-blocks such as the one described with respect to FIG. 6. When a 8×8 macroblock is aligned with image sub-blocks illustrated in FIG. 6, four image sub-blocks can be accessed in memory to represent the 8×8 macroblock (and the efficiency of memory access might be 100%). In some cases, however, a macroblock might not be aligned with the image sub-blocks. For example, FIG. 9 illustrates a display 900 divided into image blocks and image sub-blocks along with a non-aligned 8×8 macroblock 920 according to some embodiments. In this case, nine image sub-blocks need to be accessed to represent the 8×8 macroblock. In particular, the following image sub-blocks need to be accessed: B11, SB4; B2, SB3; B2, SB4; B3, SB2; B4, SB1; B4, SB2; B3, SB4; B4, SB3; and B4, SB4. As a result, this “worst case” scenario implies a 44% memory efficiency. Thus, the size of a tile might represent a balanced point of efficiency in view of addressing modes, traffic pattern mixes, and/or bandwidth. Also note that codec engines, image enhancement algorithms, and/or motion estimation may also benefit from smaller tiles. According to some embodiments, a memory space may be partitioned into both linear and tiled regions to improve memory bandwidth.

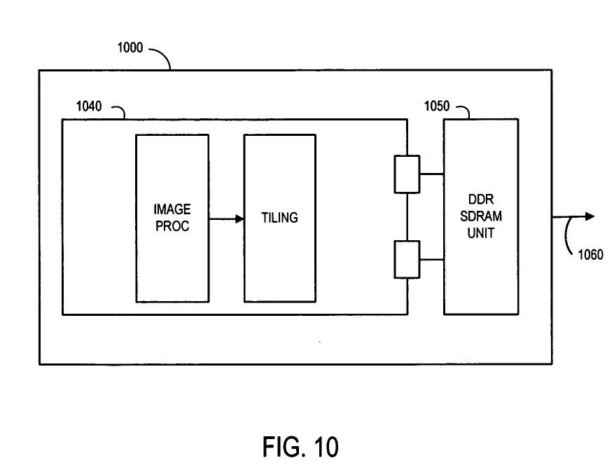

FIG. 10 is a block diagram of a system 1000 according to some embodiments. The system 1000 may be associated with, for example, a digital display device, a television, a digital video recorder, a game device, a personal computer, a wireless device, and/or a set-top box. The system 1000 may include, for example, a video processing system 1040 and/or DDR SDRAM unit 1050 according to any of the embodiments described herein. For example, the video processing system 1040 might include an image processor and a memory page tiling translator, between the image processor and the DDR SDRAM 1050, to receive a tiled virtual memory address from the image processor and to translate the received tiled virtual memory address into a tiled physical memory address. According to some embodiments, the video processing system 1040 generates information that is provided to a display device via a digital output 2430.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although a particular address mapping scheme has been described herein, embodiments may be associated with any other types of address arrangements and mapping techniques. For example, a particular decoding approach might include different sized blocks of image information than those that have been described herein as examples. As another example, pixels might instead be stored right-to-left instead of left-to-right.

Moreover, although particular image processing protocols and networks have been used herein as examples (e.g., H.264 and MPEG4), embodiments may be used in connection any other type of image processing protocols or networks, such as Digital Terrestrial Television Broadcasting (DTTB) and Community Access Television (CATV) systems.

The several embodiments described herein are solely for the purpose of illustration. Persons skilled in the art will recognize from this description other embodiments may be practiced with modifications and alterations limited only by the claims.

What is claimed is:

1. A method, comprising:
determining image information, the image information including rows of pixels;
associating the image information with a plurality of image blocks, each image block including a subset of pixels from multiple rows, wherein a single row of pixels of the image information spans multiple image blocks;
storing a first subset of pixels from a first row of a first image block into a memory unit;
storing a second subset of pixels from a second row of the first image block into the memory unit such that a first pixel of the second subset is stored proximate to a last pixel of the first subset.

2. The method of claim 1, further comprising:
storing pixels of a first image block and a second image block such that a first pixel of the second image block is stored proximate to a last pixel of the first image block.

3. The method of claim 1, further comprising:
associating each image block with a plurality of image sub-blocks, each image sub-block including a subset of pixels from multiple rows, wherein a single row of pixels of an image block spans multiple image sub-blocks;
storing a first subset of pixels from a first row of a first image sub-block into the memory unit;
storing a second subset of pixels from a second row of the first image sub-block into the memory unit such that a first pixel of the second subset is stored proximate to a last pixel of the first subset.

4. The method of claim 1, wherein said storing is associated with a translation of a virtual image memory address into a tiled physical memory address.

5. The method of claim 4, further comprising:
translating a requested virtual image memory address into a requested tiled physical memory address;
retrieving pixel data from the memory unit in accordance with the requested tiled physical memory address; and
associating the retrieved pixel data with the requested virtual image memory address.

6. The method of claim 4, wherein the memory unit is associated with a double data rate synchronous dynamic random access memory unit.

7. The method of claim 6, wherein the first pixel of the second subset is stored in a same memory unit page as the last pixel of the first subset

8. The method of claim 6, wherein said storing is associated with a multi-port, multi-channel memory controller port.

9. The method of claim 1, wherein the image information is associated with at least one of: (i) H.264 information, (ii) Motion Picture Experts Group 2 information, or (iii) Motion Picture Experts Group 4 information.

10. The method of claim 1, wherein the image information is associated with at least one of: (i) a digital display device, (ii) a television, (iii) a digital video recorder, (iv) a game device, (v) a personal computer, (vi) a wireless device, or (vii) a set-top box.

11. An apparatus, comprising:
an image processor;
a memory unit; and
a memory page tiling translator, between the image processor and the memory unit, to receive a tiled virtual memory address from the image processor and to translate the received tiled virtual memory address into a tiled physical memory address.

12. The apparatus of claim 11, wherein the image processor is associated with at least one of: (i) a codec, (ii) a display processor, or (iii) a central processing unit.

13. The apparatus of claim 11 wherein the memory unit comprises a double data rate synchronous dynamic random access memory unit.

14. The apparatus of claim 13, further comprising:
a multi-port, multi-channel memory controller port between the memory page tiling translator and the memory unit.

15. The apparatus of claim 14, wherein the controller port is to translate the tiled physical memory address into a double data rate address.

16. The apparatus of claim 11, wherein the memory page tiling translator is associated with a system on a chip.

17. An apparatus comprising:
a computer-readable storage medium having stored thereon instructions that when executed by a machine result in the following:
determining image information, the image information including rows of pixel data,
associating the image information with a plurality of macroblocks, each macroblock including a subset of pixel data from multiple rows, wherein a single row of pixel data of the image information spans multiple macroblocks;
storing a first subset of pixel data from a first row of a first macroblock into a memory unit;
storing a second subset of pixel data from a second row of the first macroblock into the memory unit such that data of a first pixel of the second subset is stored proximate to data of a last pixel of the first subset.

18. The apparatus of claim 17, wherein the image information is associated with at least one of: (i) H.264 information, (ii) Motion Picture Experts Group 2 information, or (iii) Motion Picture Experts Group 4 information.

19. A system, comprising:
an image processor;
a double data rate synchronous dynamic random access memory unit;
a memory page tiling translator, between the image processor and the double data rate synchronous dynamic random access memory unit, to receive a tiled virtual memory address from the image processor and to translate the received tiled virtual memory address into a tiled physical memory address; and
a digital output to provide a digital signal to a digital display device.

20. The system of claim 19, wherein the system is associated with at least one of: (i) a digital display device, (ii) a television, (iii) a digital video recorder, (iv) a game device, (v) a personal computer, (vi) a wireless device, or (vii) a set-top box.
